(19) United States
(12) Patent Application Publication
(10) Pub. No.: US 2005/0111300 A1
(43) Pub. Date: May 26, 2005

(54) Device for the mixing and discharge of liquid and pulverulent materials for medical use

(76) Inventors: Berthold Nies, Fraenkisch-Crumbach (DE); Hutchappa Nandeesh Nagaraj, Bangalore (IN)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/954,358

(22) Filed: Oct. 1, 2004

(30) Foreign Application Priority Data
Oct. 1, 2003 (DE) 103 45 646.5

(51) Int. Cl. B01F 13/00

(52) U.S. Cl. 366/332

(57) ABSTRACT

A device for the storage, mixing and discharge of liquid and pulverulent materials for medical use has a mixing cylinder (1), a perforated mixing plunger (8), which is axially and rotatably movable in the mixing cylinder (1) by means of an actuation rod (9), an axially displaceable discharge plunger (4), a sealable discharge aperture (3) in the mixing cylinder (1) and means for actuation of the discharge plunger (4). The discharge plunger (4) has in its interior a sealable storage chamber (14) for the accommodation of one of the materials to be mixed, so that pre-packaged amounts of the materials to be mixed can be introduced separately into the device, even without packaging, and stored over an extended period. The discharge plunger (4) engages with the mixing cylinder (1) via an actuation thread, so that rotation of the discharge plunger (4) relative to the mixing cylinder (1) enables discharge of the mixed materials. To this end, the mixing cylinder (1) has an external thread (6), which engages with an internal thread (7) of the hollow cylinder (5) partly surrounding the mixing cylinder (1), the hollow cylinder (5) having handling elements and being rigidly connected to the discharge plunger (4).

The invention relates to a device for the mixing and discharge of liquid and pulverulent materials for medical use, having a mixing cylinder, having a perforated mixing plunger which is axially and rotatably movable in the mixing cylinder by means of an actuation rod, having an axially displaceable discharge plunger, and having a sealable discharge plunger on the mixing cylinder.

In various medical treatment methods, a synthetically produced material is introduced into the body of the patient. In vertebroplasty, for example, synthetically produced, initially liquid bone cement is injected directly into the weakened bone matrix in order to support the latter and thus to prevent pain caused by deformed bones or the loss of bone mass. Since the synthetically produced material is introduced into the human or animal body and remains there over a long period, the requirements regarding good tolerability and a sterile composition and handling are very high.

Typical bone cements are composed of a liquid component, often monomer solutions of methyl methacrylate (MMA) with smaller amounts of other monomers and additives, and a solid, pulverulent component, which often essentially consists of a polymer, such as, for example, polymethyl methacrylate (PMMA). Other mixed products are typically composed of a mineral powder, such as, for example, calcium phosphate or calcium sulfate, optionally with further additives or active ingredients, such as antibiotics, and a liquid in the form of an aqueous solution of salts or another buffer solution, in particular a sodium phosphate solution. Mixtures of two paste-form components, which can have suitable properties for use in the human body, are also conceivable.

A common feature of all these synthetically produced materials is that, for production, a liquid starting component has to be intensively mixed with a further, often solid, possibly also liquid material. After mixing, the mixed product can be used and processed within a short time span before the desired solidification and curing of the mixed product commences.

Numerous devices are known which are suitable for the mixing of the materials and for introduction thereof into the human body. At least the final step, namely the discharge of the materials mixed with one another, must of course take place under sterile conditions directly in the operating room. Since, after the two starting materials have been mixed for the first time, often only a very short time is available before the ready-mixed product is used as intended, it is desirable that the mixing process too can be carried out under sterile conditions.

The end product produced by mixing can—also depending on the respective starting materials used—have a viscosity which varies over a broad range during the medical use. Specific and controlled discharge of the end product during an operation may be associated with difficulties, in particular in the case of high-viscosity end products, which may optionally also comprise finely particulate additives.

A mixing container in which the starting materials combined in a mixing cylinder can be mixed intensively by means of a hand-actuatable mixing plunger is known from practice. In order to discharge the mixed materials, the mixing cylinder is inserted into a handling device which enables controlled discharge of the mixed end product. The starting materials, which are initially stored separately, are tightly sealed in the mixing cylinder during the mixing process, enabling the hand-actuated mixing and subsequent discharge to take place under sterile conditions, for example in the operating room.

The starting components to be mixed have to be introduced into the mixing cylinder immediately before mixing, which usually takes place outside the operating room and not under sterile conditions. The filled mixing cylinder must then be sterilised in order to enable mixing and use of the mixed product in the operating room.

Although the use of the additional handling device simplifies discharge, including of high-viscosity end products, insertion of the mixing cylinder into the handling device after mixing is complete is, however, time-consuming and inconvenient, and the production and requisite sterilisation of the handling device before each use are comparatively complex. Owing to the low production costs and the disproportionately high cleaning effort, mixing cylinders in combination with mixing and discharge plungers are usually designed and produced as disposable products. However, the comparatively high production costs of the handling devices described above, which do not come into direct contact with the materials used, mean that the handling device has a re-usable design and has to be cleaned and sterilised after each use.

A device for the mixing and discharge of bone cements of the generic type mentioned at the outset which facilitates separate storage of the starting components under sterile conditions is also known (EP 0 692 229 B1). In this device, however, actuation devices for the mixing plunger have to be removed and means for actuation of the discharge plunger have to be fitted after completion of the mixing process and before discharge of the bone cement obtained by mixing. In the process, the discharge plunger is usually pushed into the mixing cylinder as an axially displaceable pressure plunger by means of a push rod to be attached to the discharge plunger, and thus expels the bone cement located therein, which exits through a discharge nozzle, which likewise subsequently has to be fitted to the mixing cylinder.

The device can be produced inexpensively and is suitable for use as disposable product. However, the handling of a device of this type is time-consuming and inconvenient owing to the requisite adaptation after the mixing process and before the discharge and, in particular in the case of high-viscosity mixed products, does not allow meterable or controlled discharge of the bone cement.

The object of the present invention is accordingly to design the simplest possible device which is inexpensive to produce in such a way that intensive mixing of the starting materials and controlled discharge thereof is facilitated at the same time as the simplest possible handling. It should be possible for the entire device to be produced and used in an economical manner as a disposable product. At least during the mixing process and discharge of the mixed materials, undesired contamination of both the environment and also of the materials used should be excluded.

This object is achieved in accordance with the invention in that means for actuation of the discharge plunger are provided in order to discharge the mixed materials through the discharge aperture by displacement of the discharge plunger in the mixing cylinder.

It is thus achieved that handling of the device during the mixing process and discharge is significantly simplified. No additional measures are necessary for, for example, adapting the device after the mixing process in such a way that simple discharge of the mixed product is facilitated. Owing to the simplified handling, the time needed during preparation and use of the mixed product is considerably reduced, enabling the duration of the surgical intervention also to be shortened and the stresses for the patient and for the surgeon to be reduced.

According to a particularly advantageous embodiment of the inventive idea, it is provided that means are provided in the device for separately accommodating and storing pre-packaged amounts of the materials to be mixed.

The materials to be mixed should in most cases only come into contact with one another and be intensively mixed immediately before discharge. While mixing and discharge of the materials is possible without problems in the operating room under sterile conditions, filling of the device with pulverulent and liquid materials represents a high risk of contamination and should advantageously take place outside the sterile operation area.

The individual starting materials can be introduced into the device in pre-packaged and separately packed units and stored there until use, but the respective packaging would then have to be removed or at least opened immediately before the mixing process. If the packaging remains in the device, it is virtually impossible to ensure residue-free intensive mixing of the starting materials with acceptable design complexity, and there is a risk, for example, of part of the packaging hindering the discharge operation or even blocking the discharge aperture.

Since the device has means for the separate accommodation and storage of the components to be mixed, the components can already be introduced into the device long before the intended use. For example, the device could be filled under sterile conditions immediately after its production, and devices which have been filled with various mixture components, depending on the application, could be offered and sold in this form. Even if the filling is carried out separately from the production and sale of the device, the separately accommodated materials can often be stored in the device for a sufficiently long period until use, so that there is no longer any necessity for filling immediately before or during use in an operation in the operating room.

According to an embodiment of the inventive idea, it is proposed that the device has two chambers which can be separated from one another in an impermeable manner and in which two materials to be mixed can be accommodated and stored separately. Liquid or pulverulent materials can be stored in the separate chambers, even over an extended period, without additional packaging means or protective coverings, such as, for example, film bags or cartons. Before combining and mixing the materials, it is not necessary first to open a package before mixing can be carried out. This significantly simplifies handling, in particular under sterile conditions.

It is preferably provided that the discharge plunger has in the interior a storage chamber for the accommodation of one of the materials to be mixed. The storage chamber in the interior of the discharge plunger is a cavity separated from the interior of the mixing cylinder. The interior of the mixing cylinder then forms, without additional measures, a second chamber separated from the storage chamber in the discharge plunger.

The storage chamber in the interior of the discharge plunger can be essentially hollow-cylindrical, with the storage chamber being limited on the outside by the cylindrical outer wall of the discharge plunger and on the inside by the inner, axial bearing of the actuation rod of the mixing plunger. The volume thus available is adequate for use of the device with the usual starting materials. It is advantageous here to introduce a liquid starting material into the storage chamber in the interior of the discharge plunger and to store it there, since substantially residue-free emptying of the storage chamber of the discharge plunger can be accomplished more easily in the case of liquid materials.

It is advantageously provided that the discharge plunger has a sealable aperture, via which, in the opened state, the material located in the storage chamber of the discharge plunger can enter the mixing cylinder. By opening this sealable aperture, a connection is made between the storage chamber in the discharge plunger and the mixing cylinder via which the starting material hitherto stored in the discharge plunger enters the mixing cylinder. In most cases, it will be sufficient to hold the device for a short time with the mixing cylinder facing downwards in such a way that the liquid enters the mixing cylinder in a downward direction from the higher discharge plunger as a consequence of gravity. On use of a paste-form starting material, however, it may also be advantageous to support emptying of the storage chamber of the discharge plunger, for example, mechanically or by means of an additionally generated excess pressure.

The sealable aperture of the discharge plunger can preferably be sealed by means of a sealing mechanism arranged at the discharge plunger end facing away from the mixing cylinder. The opening and sealing of the discharge plunger at the beginning of the mixing process in order to combine the starting materials stored to that point can then be carried out and monitored in a simple manner from the freely accessible side of the device.

The sealing mechanism advantageously has handling means for simple actuation of the sealing mechanism. Thus, for example, the opening or closing of the sealable aperture could be carried out by moving a small lever or actuating a bayonet catch.

According to an advantageous embodiment of the inventive idea, vent openings which enable controlled filling and emptying of the storage chamber are provided in the storage chamber of the discharge plunger. During filling of the storage chamber with a liquid starting material, the air expelled in the process must be able to escape from the chamber. In the same way, air must be able to flow into the interior volume becoming free during emptying of the storage chamber at the beginning of the mixing process in order to prevent a reduced pressure otherwise forming in the chamber, which would make further emptying of the storage chamber more difficult or even impossible.

The apertures used for the filling or emptying of the storage chamber can be of sufficiently large dimensions to be able to act simultaneously as vent openings. If the size of the apertures used for filling and emptying is not sufficient, additional sealable vent openings may be provided, for example at the discharge plunger end facing away from the mixing cylinder.

It is preferably provided that the discharge aperture is arranged on an end face of the mixing cylinder, and the actuation rod of the mixing plunger and the means for actuation of the discharge plunger are arranged at the opposite end of the mixing cylinder. The entire device can accordingly be constructed and used in a similar way to a syringe. For most surgical interventions, it is advantageous for the discharge aperture from which the mixed product to be introduced into the body of the patient exits to be arranged as far away as possible from handling and actuation elements of the device used.

According to a preferred embodiment of the inventive idea, it is proposed that the discharge plunger engages with the mixing cylinder via a screw thread, and rotating the discharge plunger relative to the mixing cylinder enables displacement of the discharge plunger in the mixing cylinder and discharge of the mixed materials located in the mixing cylinder. It has been found that in many cases pushing or displacing the discharge plunger manually in the mixing cylinder does not facilitate the desired precision in metering during discharge. Thus, in particular in the case of a high-viscosity mixed product, the requisite pressure during discharge of the material may be so great that uniform discharge and as far as possible movement-free positioning of the device at the site of the surgical intervention cannot be ensured in each case.

Through the use of a screw thread which converts the manual rotational movement into an axial displacement of the discharge plunger, the force that needs to be exerted for discharge is considerably reduced. The number of rotations necessary for complete discharge of the mixed product can be predetermined via the slope of the thread, with the requisite force exertion reducing with increasing number of rotations. Only in extremely rare cases is rapid discharge of virtually the entire amount of mixed product necessary, and therefore only a small number of rotations can be selected for complete discharge of the mixed product.

Since manual forces in the axial direction do not have to be exerted during discharge of the mixed product from the device, the device and in particular its discharge aperture can be positioned significantly more easily and uniformly where the mixed product being discharged is to be introduced into the body of the patient.

It is advantageously provided that the mixing cylinder has an external thread which engages with an internal thread of a hollow cylinder partly surrounding the mixing cylinder, the hollow cylinder being rigidly connected to the discharge plunger. In this way, it is avoided that the inside of the mixing cylinder has a thread. The cylindrical inner surface of the mixing cylinder, which is accordingly smooth with no projections or recesses, ensures simple sealing of the interior of the mixing cylinder and thus prevents undesired contamination of the materials located in the mixing cylinder.

The external thread on the outside of the mixing cylinder can, by contrast, readily extend into a region of the mixing cylinder which is utilised for intensive mixing of the starting components by means of the mixing plunger moved to and fro inside the mixing cylinder. The length of the movement thread can thus be prespecified independently of the mixing volume provided in the mixing cylinder in such a way that jamming of the threaded region of the mixing cylinder and the hollow cylinder surrounding the latter is substantially excluded.

According to an embodiment of the inventive idea, it is proposed that the hollow cylinder has handling elements on its outer surface in the region of the rigid connection to the discharge plunger. A plurality of elevations and/or recesses, which can be designed, for example, like a wing nut, ensure reliable handling and rotation of the hollow cylinder, even under unfavourable conditions. The hollow cylinder can also have handling elements over its entire outer surface, for example rounded-off recesses and/or shaped pieces running in the longitudinal direction and spaced out along the periphery. It is also conceivable to cover the outside of the hollow cylinder with a material which is, for example, elastic or provided with a rough surface for the purposes of better handling.

According to an embodiment of the inventive idea, it is proposed that the device can be connected in the region of the discharge aperture to a stand foot in such a way that the discharge aperture is tightly sealed. It is thus ensured that the discharge aperture is tightly sealed during the mixing process and material cannot escape, while the device can at the same time be positioned vertically on a solid support in order to allow actuation of the mixing plunger actuation rod, which then projects in an upward direction, in a simple and strength-saving manner. The stand foot furthermore enables safe storage of the already filled device until its use.

It is advantageously provided that a cannula can be connected to the discharge aperture. In vertebroplasty, for example, the initially liquid bone cement has to be introduced into the interior of a degenerated or weakened bone structure in order to support and relieve the latter. The bone cement prepared in the device can be introduced through a cannula to the desired site in the bone with virtually pinpoint accuracy without extensive preparatory surgical measures being necessary.

It is advantageously provided that a reduced pressure can be generated in the mixing cylinder during the mixing process or immediately thereafter. It has been found that undesired pore formation in the mixed product can be at least substantially reduced if a reduced pressure prevails during the mixing of the materials. To this end, it can be provided that the mixing cylinder is connected to a vacuum line, either directly or via the discharge plunger interior, which is connected to the mixing cylinder. Through suitable specification of the reduced pressure prevailing in the vacuum line or through additional valves, it must be ensured here that the starting materials to be mixed are not unintentionally sucked out of the mixing cylinder.

According to an embodiment of the inventive idea, it is proposed that the inner surfaces of the storage chamber of the discharge plunger and/or of the mixing cylinder are covered with a protective layer. Irrespective of the particular material from which the discharge plunger or the entire device is made, the protective layer prevents interaction and thus contamination of the starting materials with the material of the discharge plunger or of the mixing cylinder, even on extended storage of the starting materials already introduced. Even if the starting material introduced does not have a particularly chemically aggressive composition, unavoidable diffusion at the contact areas is also substantially prevented by means of a protective layer, even on extended storage of the filled device.

Further embodiments of the inventive idea are the subject-matter of further sub-claims. An embodiment of the invention is explained in greater detail below and is depicted in the drawing, in which:

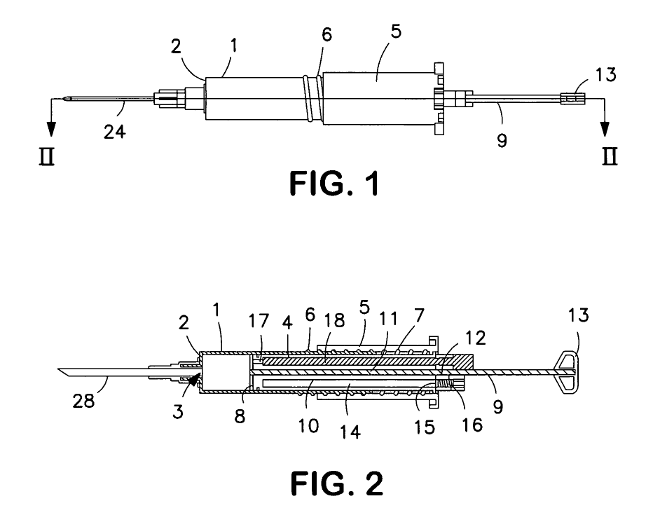

FIG. 1 shows a side view of a device for the mixing and discharge of liquid and pulverulent materials for medical use with a cannula attached thereto,

FIG. 2 shows a section along line II-II in FIG. 1,

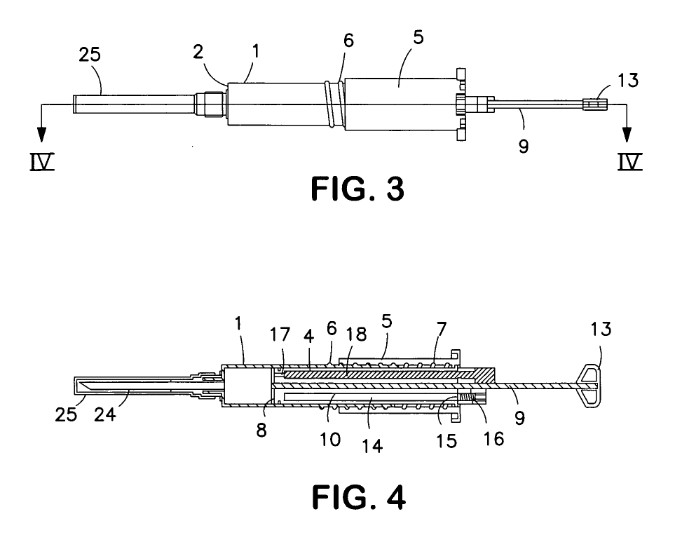

FIG. 3 shows a side view of the device depicted in FIG. 1, with the cannula covered by a protective cap,

FIG. 4 shows a section along line IV-IV in FIG. 3,

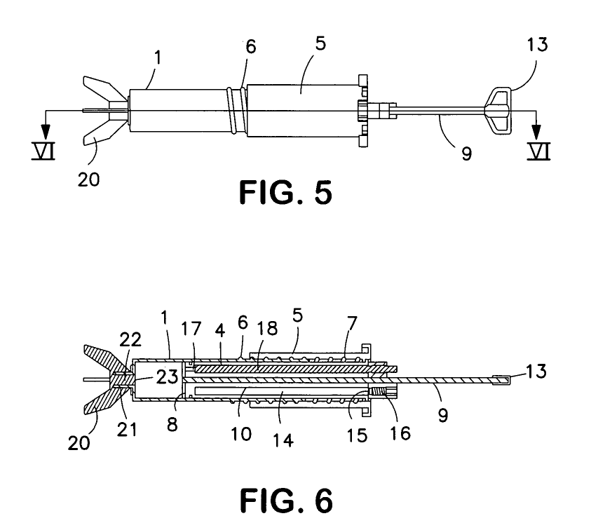

FIG. 5 shows a side view of the device depicted in FIG. 1, with, instead of the cannula, a stand foot being connected to the device,

FIG. 6 shows a section through the device depicted in FIG. 5 along line VI-VI,

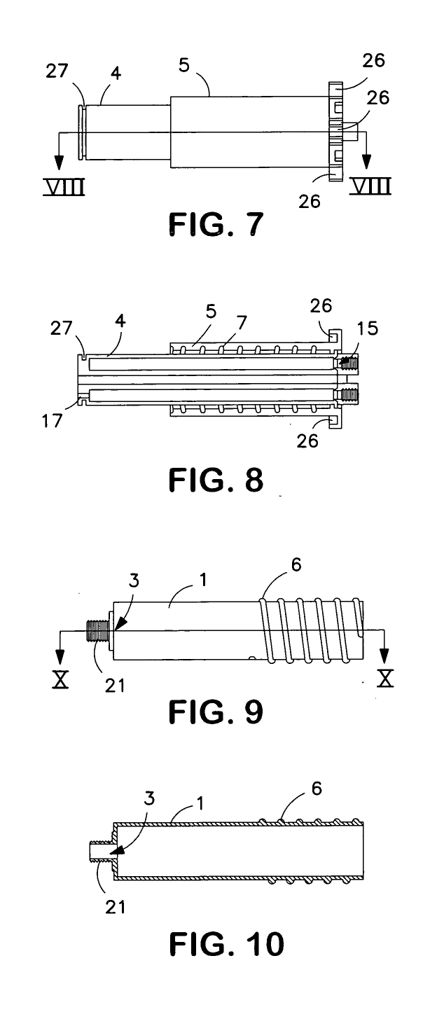

FIG. 7 shows a side view of a discharge plunger with a hollow cylinder connected thereto,

FIG. 8 shows a section through the discharge plunger depicted in FIG. 7 along line VIII-VIII,

FIG. 9 shows a side view of a mixing cylinder having an external thread,

FIG. 10 shows a section along line X-X through the mixing cylinder depicted in FIG. 9,

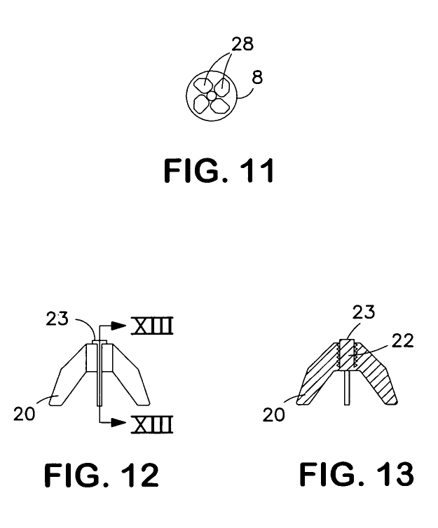

FIG. 11 shows a view of the front face of a perforated mixing plunger,

FIG. 12 shows a side view of the stand foot depicted in FIGS. 5 and 6 in combination with the device, and

FIG. 13 shows a section through the stand foot depicted in FIG. 12 along line XIII-XIII.

The device depicted in FIGS. 1 to 6 for the mixing and discharge of liquid and pulverulent materials for medical use has a mixing cylinder 1, on whose first end face 2 a discharge aperture 3 is arranged. The mixing cylinder 1 end opposite the discharge aperture 3 is essentially open. A discharge plunger 4 is arranged so as to be axially displaceable in the mixing cylinder 1, with the discharge plunger 4 projecting from the open end of the mixing cylinder 1 being rigidly connected on the far side of the mixing cylinder 1 to a hollow cylinder 5 partly surrounding the mixing cylinder 1.

The mixing cylinder 1 has on its outside an external thread 6, which engages with an internal thread 7 matched thereto on the inside of the hollow cylinder 5 partly surrounding the mixing cylinder 1. By rotating the hollow cylinder 5 relative to the mixing cylinder 1, the movement thread formed by the external thread 6 and the internal thread 7 causes a conversion of the rotational movement into a corresponding axial displacement of the hollow cylinder 5 and of the discharge plunger 4 rigidly connected thereto. By holding the mixing cylinder 1 firmly and at the same time rotating the hollow cylinder 5, an axial displacement of the discharge plunger 4 in the interior of the mixing cylinder 1 is accordingly effected, so that uniform discharge of the materials, not depicted, located in the interior of the mixing cylinder 1 takes place in accordance with the displacement caused by the discharge plunger 4 moving forwards.

A perforated mixing plunger 8 is arranged between the discharge aperture 3 and the discharge plunger 4 so as to be axially and rotatably movable in the mixing cylinder 1, and an actuation rod 9 is passed out of the mixing cylinder 1 through the discharge plunger 4 in a sealing manner. The actuation rod 9 of the mixing plunger 8 is mounted in an axially and rotatably movable manner in a bearing journal 10 formed in the interior of the discharge plunger 4. An annular seal 11 arranged along the periphery of the actuation rod at a slight separation from the front face of the mixing plunger 8 forms an air-tight seal of the interior of the mixing cylinder 1 from the environment and reliably prevents the escape of the materials stored in the mixing cylinder 1 or of the mixed materials. An annular recess 12 along the periphery of the actuation rod 9 forms a nominal breaking point, enabling the projecting end of the actuation rod 9 to be broken off and removed after the mixing process has taken place in order to simplify further handling of the device. An actuation handle 13, which has a wingnut-like design and simplifies a reliable and strong to-and-fro movement of the mixing plunger 8 in the interior of the mixing cylinder 1 and is connected to the actuation handle 13 via the actuation rod 9, is located at the projecting end of the actuation rod 9.

The discharge plunger 4 has a storage chamber 14 in the form of an essentially hollow-cylindrical recess in its interior, which serves for accommodation of the materials to be mixed before the actual mixing process. The discharge plunger 4 furthermore has at the end facing away from the mixing cylinder 1 a sealable fill aperture 15 for filling the storage chamber 14 of the discharge plunger 4. In the embodiment depicted, the fill aperture 15 is tightly sealed by means of a screwed-in pin 16.

The discharge plunger 4 has at its end facing the interior of the mixing cylinder 1 a sealable aperture 17, via which, in the opened state, the starting component located in the storage chamber 14 of the discharge plunger 4 can enter the mixing cylinder 1. The sealable aperture 17 is sealed by a sealing rod 18, which extends through the storage chamber 14 of the discharge plunger 4 and whose one end projects into the sealable aperture 17 and tightly seals the latter. The sealing rod 18 is mounted in an axially displaceable manner at the discharge plunger 4 end facing away from the mixing cylinder 1. Instead of the thread 19 shown in the embodiment depicted, which facilitates reliable opening and closing of the sealable aperture 17 by corresponding screwing-out or in of the sealing rod 18, the sealing rod 18 could alternatively be provided with a bayonet catch, which can be actuated by a small lever or the like.

The device depicted in FIGS. 1 to 6 enables simple handling during filling of the device with the starting materials, during the mixing process and the subsequent discharge of the mixed materials.

In order to fill the device, firstly the discharge plunger 4 together with the mixing plunger 8 connected thereto is completely removed from the mixing cylinder 1. A component of the starting materials to be mixed, usually a pulverulent material, is introduced into the interior of the mixing cylinder 1. The interior of the mixing cylinder 1 is subsequently tightly sealed again by the discharge plunger 4. In the process, the discharge plunger 4 is inserted so far into the mixing cylinder 1 that the remaining volume of the interior of the mixing cylinder 1 is sufficient also later completely to accommodate the second component of the materials to be mixed and to facilitate intensive mixing of the materials. The fill aperture 15 of the storage chamber 14 in the discharge plunger 4 is then opened, and the second, usually liquid component of the materials to be mixed is introduced into the storage chamber 14 of the discharge plunger 4. The fill aperture 15 is subsequently tightly sealed again by screwing the pin 16 into the fill aperture 15. The filled and tightly sealed device can then be stored outside or inside the operating room until use under sterile conditions.

Before commencement of the mixing process, the sealing rod 18 must firstly be detached and the sealable aperture 17 opened. In most cases, simply positioning the device upright for a short time is sufficient to ensure complete exit of the liquid located in the storage chamber 14 of the discharge plunger 4 into the mixing cylinder 1 then located beneath. If high-viscosity starting materials are introduced into the hollow-cylindrical interior of the storage chamber 14 of the discharge plunger 4, so that it is feared that residue-free emptying cannot occur before commencement of the mixing process, additional means, not shown, can be used in order to ensure substantially residue-free emptying of the discharge plunger 4.

After the sealable aperture 17 of the discharge plunger 4 has been sealed again after emptying, intensive mixing of the components now combined in the mixing cylinder 1 can be carried out by repeated displacement of the perforated mixing plunger 8 in the interior 14 of the mixing cylinder 1.

The discharge aperture 3 here is advantageously sealed by a stand foot 20, which is also depicted in FIGS. 5 and 6. The stand foot 20 is connected via a thread to a connector 21, matched thereto, of the discharge aperture 3 in the case of a stand foot 20 fully connected to the device, a concentric shaped piece 21 projects so far into the connector 21 of the discharge aperture 3 that the front face 23 of the concentric shaped piece 21 terminates the interior of the mixing cylinder 1 in a flush manner. In this way, a dead space in the interior of the mixing cylinder 1, in which only incompletely mixed quantities of the starting components could collect, is avoided during the mixing process.

The device can be placed upright on a flat support by means of the stand foot 20, so that the actuation rod 9 projects upwards and the actuation handle 13 is readily accessible. Simple up and down movement of the actuation rod 9 then causes a corresponding displacement of the perforated mixing plunger 8 and thus the desired mixing of the starting materials.

After sufficient mixing of the materials, the stand foot 20 can be screwed off and replaced by a cannula 24. Rotation of the hollow cylinder 5 relative to the firmly held mixing cylinder 1 pushes the discharge plunger 4 increasingly into the mixing cylinder 1 and expels the mixed product, not depicted in the figure, located therein, which exits through the cannula 24. The discharge plunger 4 pushes the mixing plunger 8 in front of itself during its advance in the interior of the mixing cylinder 1 without this resulting in a detectable impairment of the discharge operation. If desired for simpler handling of the device, the part of the actuation rod 9 which is no longer required can be broken off and removed together with the actuation handle 13 at the nominal breaking point 12 of the actuation rod 9.

For safety reasons, the cannula 24 can be covered with a protective cap 25 before or during an operation or subsequently thereto if the device is not used.

For clarification, FIGS. 7 to 10 depict the discharge plunger 4 again separately together with the hollow cylinder 5 and the mixing cylinder 1. On its outer surface in the region of the rigid connection to the discharge plunger 4, the hollow cylinder 5 has handling elements in the form of a plurality of rounded-off shaped pieces 26 arranged at a distance from one another. At its end facing the mixing cylinder 1, the discharge plunger 4 has an annular recess 27 running along the periphery, which is suitable for accommodation of a sealing ring or similar sealing means and reliably seals the interior of the mixing cylinder 1 from the environment.

FIG. 11 depicts the front face of the perforated mixing plunger 8, showing the design and arrangement of the individual perforations 28.

For clarification, the stand foot 20 already shown in FIGS. 5 and 6 and described in this connection is depicted separately in FIGS. 12 and 13.

The individual elements of the device depicted in the figures can be produced predominantly from polycarbonates or polypropylene and by injection moulding. If necessary, the actuation rod 9 or the pin 16 or the sealing rod 18, for example, can be made of aluminium or another material of sufficient strength. For certain applications, it may be advantageous or necessary for the inner surfaces of the recess 14 of the discharge plunger 4 and of the mixing cylinder 1 to be coated with a chemically resistant protective layer, for example a thin Teflon or glass coating.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure[s] of all applications, patents and publications, cited herein and of corresponding German application No. 103 45 646.5, filed Oct. 1, 2003 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Device for the mixing and discharge of liquid and pulverulent materials for medical use, having a mixing cylinder (1), having a perforated mixing plunger (8), which is axially and rotatably movable in the mixing cylinder (1) by means of an actuation rod (9), having an axially displaceable discharge plunger (4) and having a sealable discharge aperture (3) in the mixing cylinder (1), characterised in that means are provided for actuation of the discharge plunger (4) in order to discharge the mixed materials through the discharge aperture (3) by displacing the discharge plunger (4) in the mixing cylinder (1).

2. Device according to claim 1, characterised in that means are provided in the device for separately accommodating and storing pre-packaged amounts of the materials to be mixed.

3. Device according to claim 1, characterised in that the device has two chambers which can be separated from one another in an impermeable manner and in which two materials to be mixed can be accommodated and stored separately

4. Device according to claim 3, characterised in that the discharge plunger (4) has in the interior a storage chamber (14) for accommodation of one of the materials to be mixed.

5. Device according to claim 4, characterised in that two materials to be mixed can be accommodated separately in the mixing cylinder (1) and in a storage chamber (14) in the interior of the discharge plunger (4).

6. Device according to claim 5, characterised in that the discharge plunger (4) has a sealable aperture (17), via which, in the opened state, the material located in the interior (14) of the discharge plunger (4) can enter the mixing cylinder (1).

7. Device according to claim 6, characterised in that the sealable aperture (17) of the discharge plunger (4) can be actuated by means of a sealing mechanism arranged at the discharge plunger (4) end facing away from the mixing cylinder (1).

8. Device according to claim 7, characterised in that the sealing mechanism has a sealing rod (18) which is mounted in an axially displaceable manner at the discharge plunger (4) end facing away from the mixing cylinder (1), and the sealable aperture (17) can be opened or closed by actuation of the sealing rod (18).

9. Device according to claim 7, characterised in that the sealing mechanism has handling means for simple actuation.

10. Device according to claim 4, characterised in that the discharge plunger (4) has, at the end facing away from the mixing cylinder (1), a sealable fill aperture (15) for filling the storage chamber (14) of the discharge plunger (4) with one of the materials to be mixed.

11. Device according to claim 4, characterised in that vent openings which enable controlled filling and emptying of the chamber (14) are provided in the chamber (14) of the discharge plunger (4).

12. Device according to claim 1, characterised in that the discharge aperture (3) is arranged on an end face (2) of the mixing cylinder (1), and the actuation rod (9) of the mixing plunger (8) and the means for actuation of the discharge plunger (4) are arranged at the opposite end of the mixing cylinder (1).

13. Device according to claim 1, characterised in that the mixing plunger (8) is arranged between the discharge aperture (3) and the discharge plunger (4) in the mixing cylinder (1), and the actuation rod (9) of the mixing plunger (8) is passed out through the discharge plunger (4) in a sealing manner.

14. Device according to claim 1, characterised in that the discharge plunger (4) engages with the mixing cylinder (1) via a thread, and rotation of the discharge plunger (4) relative to the mixing cylinder (1) enables displacement of the discharge plunger (4) in the mixing cylinder and discharge of the mixed materials located in the mixing cylinder.

15. Device according to claim 1, characterised in that the mixing cylinder (1) has an external thread (6) which engages with an internal thread (7) of a hollow cylinder (5) partly surrounding the mixing cylinder (1), the hollow cylinder (5) being rigidly connected to the discharge plunger (4).

16. Device according to claim 15, characterised in that the mixing cylinder (1) end opposite the discharge aperture (3) is essentially open, and the discharge plunger (4) projecting from the open end is rigidly connected on the far side of the mixing cylinder (1) to the hollow cylinder (5) partly surrounding the mixing cylinder (1).

17. Device according to claim 15, characterised in that the hollow cylinder (5) has handling elements on its outer surface in the region of the rigid connection to the discharge plunger (4).

18. Device according to claim 15, characterised in that the hollow cylinder (5) has handling elements over its entire outer surface.

19. Device according to claim 1, characterised in that the device can be connected in the region of the discharge aperture (3) to a stand foot (20) in such a way that the discharge aperture (3) is tightly sealed.

20. Device according to claim 1, characterised in that a cannula (24) can be connected to the discharge aperture (3).

21. Device according to claim 1, characterised in that a reduced pressure can be generated in the mixing cylinder (1) during the mixing process or immediately thereafter.

22. Device according to claim 1, characterised in that the inner surfaces of the storage chamber (14) of the discharge plunger (4) and/or of the mixing cylinder (1) are covered with a protective layer.
